(19) United States
(12) Patent Application Publication
(10) Pub. No.: US 2013/0007351 A1
(43) Pub. Date: Jan. 3, 2013

(54) INFORMATION PROCESSOR, INFORMATION PROCESSING METHOD, AND COMPUTER PROGRAM PRODUCT

(76) Inventor: Fujihito Numano, Tokyo (JP)

(21) Appl. No.: 13/439,633

(22) Filed: Apr. 4, 2012

(30) Foreign Application Priority Data
Jul. 1, 2011 (JP) 2011-147676

(51) Int. Cl. G06F 12/02

(52) U.S. Cl. 711/103; 711/E12.008

(57) ABSTRACT

According to one embodiment, an information processor includes: a first storage comprising a nonvolatile semiconductor memory configured to store therein data specific to a user in association with identification information for identifying the user; a second storage used as a work area; a manager configured to copy the specific data stored in the first storage to the second storage at a predetermined timing; a logon module configured to allow a specific user to logon to the information processor by using the identification information; a determination module configured to determine whether the specific data corresponding to identification information of the logged-on user is stored in the second storage; and a processor configured to perform a predetermined process by using the specific data stored in the second storage when the first determination module determines the specific data corresponding to the identification information of the logged-on user is stored in the second storage.

### CROSS-REFERENCE TO RELATED APPLICATIONS

This application is based upon and claims the benefit of priority from Japanese Patent Application No. 2011-147676, filed Jul. 1, 2011, the entire contents of which are incorporated herein by reference.

### FIELD

Embodiments described herein relate generally to an information processor, an information processing method, and a computer program product.

### BACKGROUND

In recent years, information processors, such as broadcast receivers, equipped with a call function using IP phones have been in widespread use. In such information processors, identification information, such as a user ID, for identifying each user is managed in association with user specific data, so that usage environment of the IP phones can be selectively provided depending on users.

Furthermore, in recent years, nonvolatile semiconductor memories, such as flash memories, are used as recording media for storing various types of data. In such recording media, it is desirable to suppress the number of times of rewrite in order to extend the life of the recording media. Conventionally, as a technique for suppressing the number of times of rewrite, a technique has been proposed, in which a buffer is provided between a host that reads/writes data and a nonvolatile semiconductor memory and data in the buffer is written back to the nonvolatile semiconductor memory depending on whether a logical page of a data write destination matches a logical page of a data write destination contained in the buffer.

However, a configuration that allows for data management for each user is not taken into account in the conventional technique described above. Therefore, when pieces of user specific data are stored in the nonvolatile memory, it is difficult to efficiently access (read/write) the nonvolatile memory, so that specific data may be inappropriately read or written when users are switched.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating a use environment for an information processor (digital television receiver) according to a first embodiment;

FIG. 2 is an exemplary diagram illustrating a configuration of the digital television receiver in the first embodiment;

FIG. 3 is an exemplary diagram illustrating a data structure of IP phone data;

FIG. 4 is an exemplary block diagram illustrating a functional configuration of an IP phone module;

FIG. 5 is an exemplary diagram illustrating a data structure of call data;

FIG. 6 is an explanatory diagram illustrating an example of a logon screen;

FIG. 7 is an explanatory diagram illustrating an example of a call function screen;

FIG. 8 is an exemplary flowchart of a procedure of a data management process at the time of activation in the first embodiment;

FIG. 9 is an exemplary flowchart of a procedure of a data management process after logon in the first embodiment;

FIG. 10 is an exemplary flowchart of a procedure of a data management process at the time of termination in the first embodiment;

FIG. 11 is an exemplary diagram illustrating a configuration of a digital television receiver according to a second embodiment;

FIG. 12 is an exemplary flowchart of a procedure of a data management process at the time of activation in the second embodiment;

FIG. 13 is an exemplary flowchart of a procedure of a data management process at the time of logon in the second embodiment;

FIG. 14 is an exemplary flowchart of a procedure of a data management process after the logon in the second embodiment; and

FIG. 15 is an exemplary flowchart of a procedure of a data management process at the time of termination in the second embodiment.

### DETAILED DESCRIPTION

In general, according to one embodiment, an information processor comprises a first storage, a second storage, a data manager, a logon module, a first determination module, and a processor. The first storage comprises a nonvolatile semiconductor memory configured to store therein specific data that is specific to a user in association with identification information for identifying the user. The second storage is configured to be used as a work area. The data manager is configured to copy the specific data stored in the first storage to the second storage at a predetermined timing. The logon module is configured to allow a specific user to logon to the information processor by using the identification information. The first determination module is configured to determine whether the specific data corresponding to identification information of the logged-on user is stored in the second storage. The processor is configured to perform a predetermined process by using the specific data stored in the second storage when the first determination module determines that the specific data corresponding to the identification information of the logged-on user is stored in the second storage.

Exemplary embodiments will be described in detail below with reference to the accompanying drawings. In the following embodiments, a case will be explained that the embodiments are applied to a digital television receiver; however, the embodiments are not limited thereto.

### First Embodiment

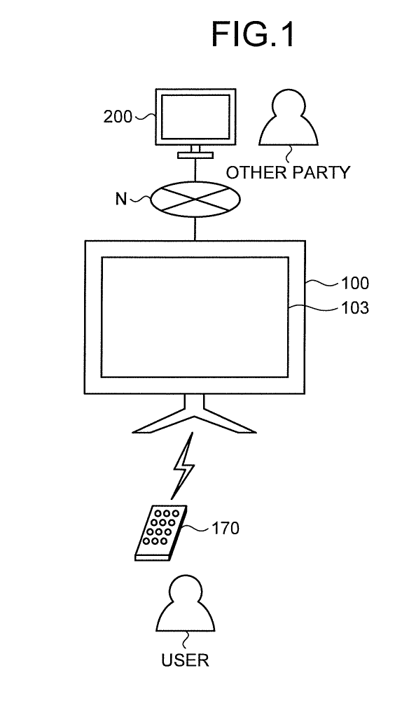

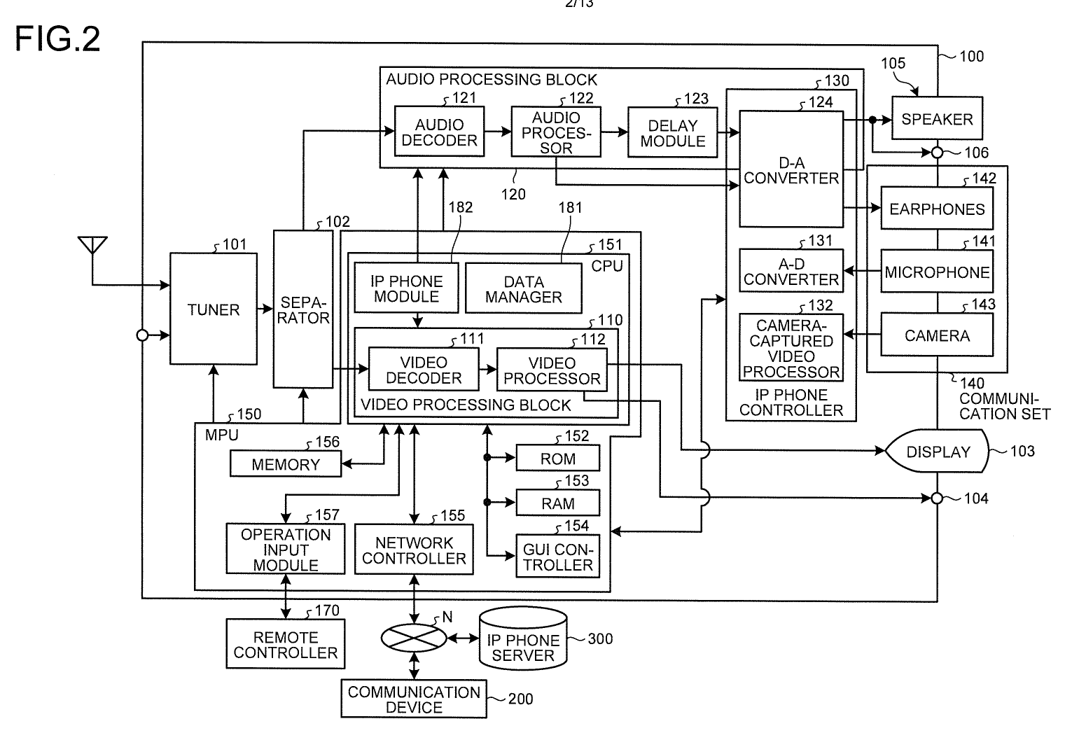

FIG. 1 is a diagram illustrating a use environment for a digital television receiver 100 as an information processor according to a first embodiment. As illustrated in FIG. 1, the digital television receiver 100 is equipped with a function of displaying received program contents on a display 103. The digital television receiver 100 is connected to a communication device 200 that is another information processor and an IP phone server 300 (see FIG. 2) to be described later, via a network N, such as an Internet communication line.

The digital television receiver 100 is also equipped with a function of enabling calls using IP phones to and from the communication device 200 connected thereto via the network N (hereinafter, this function is described as an IP phone function). A remote controller 170 is used for selecting a program as well as for making calls.

In the digital television receiver 100, a user ID unique to each user who uses the IP phone function is assigned as identification information. When a user who is to use the IP phone function inputs a user ID and a password via the remote controller 170, the digital television receiver 100 determines whether a combination of the input user ID and password is authorized. When determining that the combination is authorized, the digital television receiver 100 provides an IP phone usage environment corresponding to the user.

FIG. 2 is a diagram illustrating an example of a configuration of the digital television receiver 100 in the first embodiment. The components, configurations, and functions described below may be realized by hardware or software using a microcomputer (a processor or a CPU) or the like.

The digital television receiver 100 includes a digital television receiver that receives television broadcasts and reproduces sounds (audio) and pictures (video).

The digital television receiver 100 receives and reproduces at least digital broadcast programs, i.e., contents. The digital television receiver 100 can receive contents that are provided via the network N. The digital television receiver 100 can transmit/receive audio and video to/from any party connected thereto through the network N by using the IP phone function. The digital television receiver 100 is connected to the IP phone server 300 via the network N.

The IP phone server 300 is a server that manages information related to accounts, presence, and the like of users who use IP phones over the network N. For example, the IP phone server 300 manages a combination of a user ID and a password as the account of each of the users who use the IP phones. The IP phone server 300 also functions as an authentication server that compares a combination of a user ID and a password sent from an external apparatus, such as the digital television receiver 100 or the communication device 200, with a combination of a user ID and a password that the IP phone server 300 manages, and returns information indicating that the user is authorized to the external apparatus when the combinations match each other.

The IP phone server 300 collects and manages the presence in connection with each user ID sent from the external apparatus, such as the digital television receiver 100 or the communication device 200. The presence is information indicating the state of a user, such as “online”, “offline”, “absent”, or “on the phone”. When receiving a request for the presence of a specific user ID from the external apparatus, the IP phone server 300 provides the external apparatus with the presence of the user ID.

A tuner 101 of the digital television receiver 100 functions as a broadcast data input module and receives broadcast contents (programs) containing audio data via an antenna or an external input terminal. A separator 102 separates the broadcast contents received by the tuner 101 into video data and audio data.

The video data separated by the separator 102 is input to a video processing block 110. The video processing block 110 comprises a video decoder 111 and a video processor 112.

The video decoder 111 decodes the video data separated by the separator 102 and outputs the decoded video data to the video processor 112.

The video processor 112 processes the video data output from the video decoder 111 so that the video data can be displayed on the display 103 on the subsequent stage. The video processor 112 in the first embodiment converts the video data to data with a predetermined resolution, a frame rate, and an output format, e.g., interlace (i)/non-interlace (p). The video processor 112 sends the converted video data to the display 103. It may be possible to select an output terminal 104 to which an external monitor or a projection device (projector) is connectable, as a destination to which the video processor 112 outputs the video data.

Meanwhile, the audio data separated by the separator 102 is input to an audio processing block 120. The audio processing block 120 comprises an audio decoder 121, an audio processor 122, a delay module 123, and a D-A converter 124.

The audio decoder 121 decodes the input audio data and outputs the decoded audio data to the audio processor 122. The audio data decoded by the audio decoder 121 is input to the audio processor 122. The audio processor 122 processes the input audio data so that the audio data can be reproduced by an audio output device, and outputs the audio data to the delay module 123. The delay module 123 gives a delay for a predetermined time to the input audio data so that the audio data becomes temporally consistent with the video data output by the video processor 112 (output of audio is delayed). The audio data to which the delay is given is input to the D-A converter 124. The D-A converter 124 obtains analog audio output from the input audio data.

The analog audio that is output from the D-A converter 124 is input to, for example, a speaker 105. The analog audio that is output from the D-A converter 124 may be divided and output to an output terminal 106 to which an audio visual (AV) amplifier or the like is connectable.

The audio data to which the delay for the predetermined time is given by the delay module 123 can also be input to an IP phone controller 130. The IP phone controller 130 is connectable to a communication set 140. The communication set 140 comprises, for example, a microphone 141, earphones 142, and a camera 143. A speaker that reproduces low-output audio may be used as an audio reproducer, instead of the earphones 142. The camera 143 captures an image of a face of a user who is a viewer of the digital television receiver 100.

The IP phone controller 130 comprises an A-D converter 131 and a camera-captured video processor 132 and shares the D-A converter 124 that outputs analog audio with the audio processing block 120. The A-D converter 131 converts the analog audio that is input from the microphone 141 to audio data. The camera-captured video processor 132 performs processes on data input from the camera 143 to thereby generate video data.

A main control block (MPU) 150 controls the speaker 105, the tuner 101, the separator 102, the audio processing block 120, and the IP phone controller 130 of the digital television receiver 100 and causes them to perform predetermined operations.

The main control block 150 comprises a central processing unit (CPU) 151 as a controller for controlling the digital television receiver, and comprises a ROM 152, a RAM 153, a GUI controller 154, and a network controller 155.

The ROM 152 stores therein various operation programs. The RAM 153 is used as a work area. The GUI controller 154 generates a graphical user interface (GUI) to be displayed on the display 103 and processes user input obtained via the GUI.

The network controller 155 is connected to the network N and transmits/receives various types of data to/from external apparatuses connected to the network N. In the embodiment, the network controller 155 transmits/receives call data used for making calls using the IP phone function to/from the communication device 200. The network controller 155 communicates with the IP phone server 300 in relation to authentication of the account or transmission/reception of the presence.

The CPU 151 is connected to a memory 156. The memory 156 is a storage using rewritable nonvolatile semiconductor memories, such as flash memories or solid state drives (SSDs), as recording media, and stores therein IP phone setting data 160 or the like.

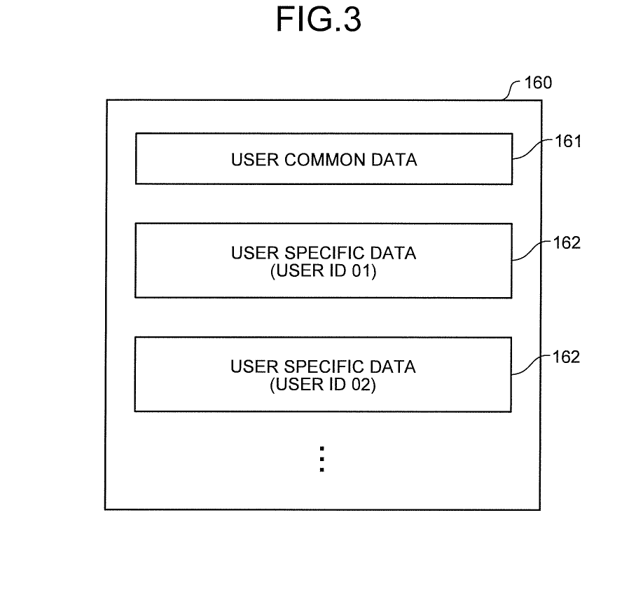

FIG. 3 is a diagram illustrating a data structure of the IP phone setting data 160. As illustrated in FIG. 3, the IP phone setting data 160 comprises user common data 161 and user specific data 162.

The user common data 161 stores therein data common to all of the users who use the IP phones. The user common data 161 stores therein, for example, setting information, such as network settings related to connections with the IP phone server 300 or setting of volume for outputting audio to the speaker 105 or the earphones 142.

The user specific data 162 is provided for each of the users who use the IP phones, and is stored in association with a user ID of each user (in the figure, user IDs 01, 02, . . . , etc.). The user specific data 162 stores therein, for example, user specific data, such as a list in which user IDs of friends and the like who are the parties of a call is registered (hereinafter, the list is described as a contact list), an incoming/outgoing call history of the IP phone, personal information such as a name and an address, and logon date and time of the latest logon. It is assumed here that the presence is associated with each of the user IDs registered in the contact list. The method for associating the user specific data 162 and the user IDs is not specifically limited. For example, it is possible to store the user specific data 162 in a directory named after each user ID.

Referring back to FIG. 2, the main control block 150 is connected to an operation input module 157. The operation input module 157 receives control input from a user. The operation input module 157 comprises a channel key (a button) for specifying a channel to be selected by the tuner 101 or a power switch for turning on and off the power. The operation input module 157 also receives instructions and control input from the remote controller 170. The operation input module 157 may be connected to a key operation input module (a keyboard) for inputting characters, symbols, numbers, or the like.

The remote controller 170 comprises a channel key, a power switch, and various operation keys for making calls using the IP phones. When an operation using the operation keys is performed, the operation input module 157 receives an instruction or the like based on the operation.

The CPU 151 reads an operation program stored in the ROM 152 and thereafter performs control in accordance with the operation program by using the RAM 153 as a work area. The operation program contains various applications, such as an operating system (OS), a TV program, a video processing program, and an IP phone program, as well as various drivers.

The video processing program is a program for realizing the video processing block 110 (the video decoder 111 and the video processor 112) described above.

The IP phone program is a program for realizing a data manager 181 and an IP phone module 182. The IP phone program may contain a function provided by known programs. For example, the IP phone program may use a function of the Internet phone “Skype” provided by the Skype (registered trademark) Limited.

The data manager 181 is a functional module that manages various types of data related to implementation of an IP phone. The data manager 181 copies the user common data 161 stored in the memory 156 to the RAM 153 when the IP phone program is activated, so that the user common data 161 is used for the execution of the IP phone program.

The IP phone program makes network settings or volume settings on the basis of the user common data 161 copied to the RAM 153. In the first embodiment, the IP phone program is activated by turning on the power of the digital television receiver 100.

The data manager 181 determines whether the user specific data 162 corresponding to the user ID of a logged-on user is stored in the RAM 153. When determining that the user specific data is not stored, the data manager 181 reads the user specific data 162 of the user ID from the memory 156 and copies it to the RAM 153.

When determining that the user specific data 162 corresponding to a user ID other than the user ID of the logged-on user is stored in the RAM 153, the data manager 181 updates the corresponding user specific data 162 in the memory 156 with the user specific data 162 stored in the RAM 153, and deletes the user specific data 162 from the RAM 153. Thereafter, the data manager 181 reads the user specific data 162 corresponding to the user ID of the logged-on user from the memory 156 and copies it from the memory 156 to the RAM 153.

When the user specific data 162 corresponding to the user ID of the logged-on user is not stored both in the RAM 153 and the memory 156, the data manager 181 determines that the user is a new user and generates the user specific data 162 corresponding to the user ID of the logged-on user in the RAM 153.

At the time of the termination of the IP phone program, the data manager 181 updates the user common data 161 in the memory 156 with the user common data 161 stored in the RAM 153. Furthermore, at the time of the termination of the IP phone program, the data manager 181 determines whether the user specific data 162 corresponding to any user ID is stored in the RAM 153. When the user specific data 162 corresponding to any user ID is stored, the data manager 181 updates the corresponding user specific data 162 in the memory 156 with the user specific data 162 stored in the RAM 153.

The IP phone module 182 packetizes audio data that represents user's voice collected by the microphone 141 of the communication set 140, and transmits the audio data to a communication destination connected via the network N. When the camera 143 is used, the IP phone module 182 packetizes video data obtained by imaging a user, and transmits the video data together with the audio data.

When receiving information from the communication destination via the network controller 155, the IP phone module 182 separates audio data (second audio data) and video data from the information and decodes the audio data and the video data. The decoded audio data is output to the audio processing block 120. The audio data is processed by the audio processor 122 of the audio processing block 120 and then output to the D-A converter 124. Therefore, voice of the other party is output from the speaker 105 or the earphones 142.

Meanwhile, the decoded video data is output to the video processing block 110. The video processor 112 of the video processing block 110 can reproduce still images as represented by joint photographic experts group (JPEG), as the decoded video data, and can reproduce moving images as represented by a moving picture experts group (MPEG)-2 or MPEG-4 (H.264-AVC). In this way, the video processor 112 performs processes for reproducing the video data using the IP phones, in addition to processes for reproducing contents.

The IP phone module 182 displays a display screen for the IP phone (a call function screen or the like, which will be described later) on the display 103 or the like, on the basis of the user specific data 162 stored in the RAM 153. Therefore, usage environment corresponding to the logged-on user is provided.

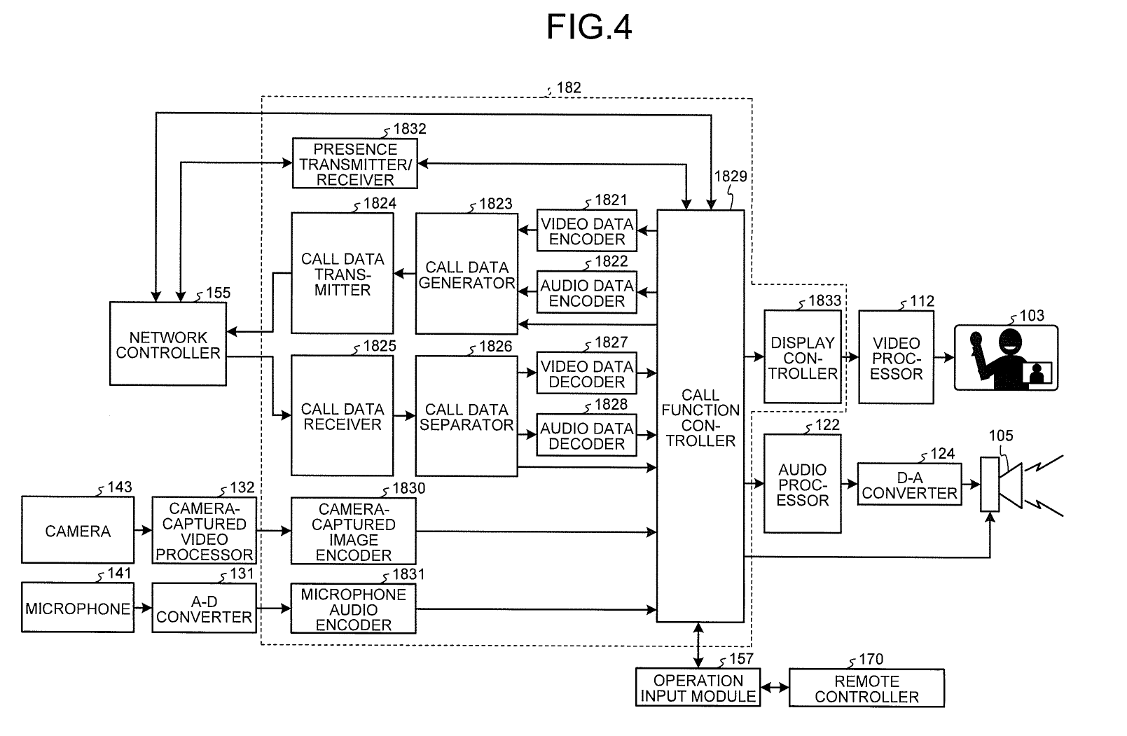

FIG. 4 is a block diagram of a functional configuration of the IP phone module 182. As illustrated in FIG. 4, the IP phone module 182 comprises a video data encoder 1821, an audio data encoder 1822, a call data generator 1823, a call data transmitter 1824, a call data receiver 1825, a call data separator 1826, a video data decoder 1827, an audio data decoder 1828, a call function controller 1829, a camera-captured image encoder 1830, a microphone audio encoder 1831, a presence transmitter/receiver 1832, and a display controller 1833.

In the digital television receiver 100 of the first embodiment, the IP phone function can be realized by the above configuration.

In the first embodiment, when a call is made by using IP phones between the digital television receiver 100 and the communication device 200, call data is transmitted and received between the digital television receiver 100 and the communication device 200.

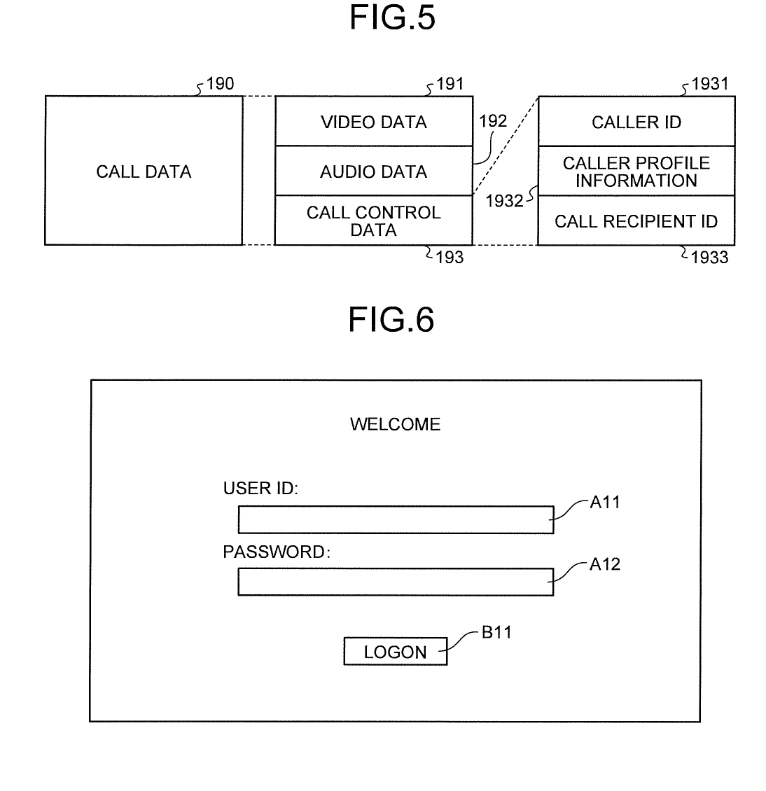

FIG. 5 is a diagram illustrating a data structure of the call data. As illustrated in FIG. 5, call data 190 comprises video data 191, audio data 192, and call control data 193. The video data 191 is data obtained by encoding video that is input from the camera 143. The audio data 192 is data obtained by encoding audio that is input from the microphone 141.

The call control data is data used for controlling implementation of the IP phone. The call control data 193 of the first embodiment comprises a caller ID 1931, caller profile information 1932, and a call recipient ID 1933.

The caller ID 1931 stores therein a user ID of a caller (a user at the source of the call). The call recipient ID 1933 stores therein a user ID of a recipient of a call (a user at the destination of the call). The caller profile information 1932 stores therein personal information such as an IP address of the caller, a machine specific address, and a name and an address of the caller.

By transmitting and receiving the call data 190, it is possible to make calls using IP phones between communication devices including the digital television receiver 100.

The digital television receiver 100 of the first embodiment transmits IP phone data containing video data captured by the camera 143 and audio data collected by the microphone 141, via the network controller 155 at the time a call is made by the IP phone. Furthermore, the digital television receiver 100 displays the video data separated from the IP phone data received by the network controller 155 on the display 103 and outputs the audio data separated from the received IP phone data through the speaker 105. The video data in the first embodiment may be moving image data or still image data.

Moreover, the digital television receiver 100 receives user's instructions from the remote controller 170 via the operation input module 157 and controls a television function and the IP phone function.

Referring back to FIG. 4, the camera-captured image encoder 1830 performs an encoding process on the video data generated by the camera-captured video processor 132 to thereby acquire the video data captured by the camera 143.

The microphone audio encoder 1831 performs an encoding process on the audio data converted by the A-D converter 131 to thereby acquire the audio data collected by the microphone 141.

The call data receiver 1825 receives call data that is information used for communication, from the communication device 200 via the network controller 155. The call data received by the call data receiver 1825 is output to the call data separator 1826.

The call data separator 1826 separates the call data input from the call data receiver 1825 into the video data 191, the audio data 192, and the call control data 193. The separated call control data 193 is input to the call function controller 1829 as it is.

The video data decoder 1827 performs a decoding process on the separated video data 191 and outputs the decoded video data to the call function controller 1829. The audio data decoder 1828 performs a decoding process on the separated audio data 192 and outputs the decoded audio data to the call function controller 1829.

The call function controller 1829 controls a function of making calls using the IP phones with the communication device 200. For example, when the user logs on, the call function controller 1829 transmits a combination of a user ID and a password input by the user to the IP phone server 300 via the network controller 155. When receiving a reply indicating that the user is authorized from the IP phone server 300, the call function controller 1829 accepts the logon. In the first embodiment, it is explained that the user authentication is performed by using the IP phone server 300; however, this is not limited thereto. It is possible to store a password of each user in the user specific data 162 or the like and perform the user authentication by the digital television receiver.

When the call control data 193 separated by the call data separator 1826 is input, the call function controller 1829 determines whether the call recipient ID 1933 contained in the call control data 193 matches the user ID of the logged-on user. When determining that the IDs match each other, the call function controller 1829 accepts to receive the call.

The presence transmitter/receiver 1832 generates the presence of the logged-on user on the basis of the operating state of the call function controller 1829 or the operating state of the network controller 155, and transmits the presence to the IP phone server 300. The presence transmitter/receiver 1832 transmits a request for the presence of each user ID registered in the contact list at a predetermined time interval (e.g., at a one-minute interval) to the IP phone server 300 on the basis of the contact list in the user specific data 162 stored in the RAM 153, and receives the presence from the IP phone server 300. The presence transmitter/receiver 1832 updates the presence in the contact list by using the received presence of each user ID.

The display controller 1833 is a functional module that controls the screen display related to the IP phone. Specifically, when logon is instructed via the remote controller 170 or the like, the display controller 1833 superimposes the video data 191 of a transmitter side, which is decoded by the video data decoder 1827, onto the video data of a receiver side, which is input from the camera-captured image encoder 1830, and then outputs the superimposed data to the video processor 112. The display controller 1833 generates a GUI in which each user ID registered in the contact list is associated with an icon image corresponding to the presence of the user ID, on the basis of the contact list in the user specific data 162 stored in the RAM 153, and outputs the GUI to the video processor 112. It is possible to generate the GUI through cooperation between the display controller 1833 and the GUI controller 154.

FIG. 6 is an explanatory diagram illustrating an example of a logon screen displayed on the display 103. The logon screen contains an area A11 for inputting a user ID, an area A12 for inputting a password, and a button B11 for confirming input. When a user who uses the IP phone inputs a user ID and a password in the areas A11 and A12, respectively, via the remote controller 170 or the like, and then selects the button B11, the input combination of the user ID and the password is confirmed.

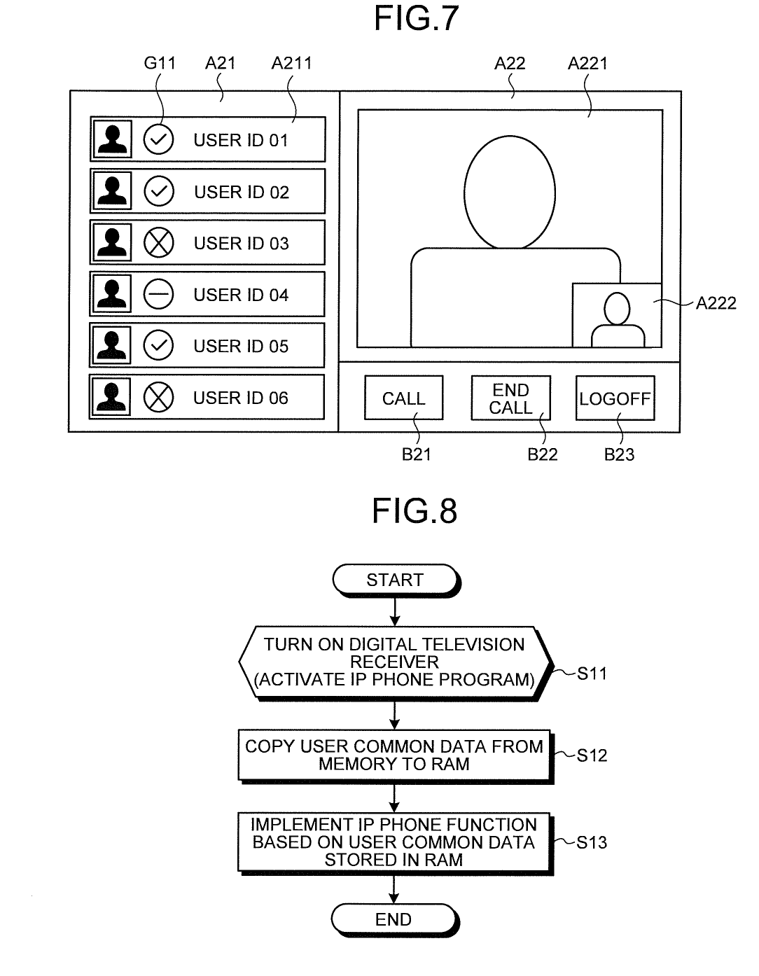

FIG. 7 is an explanatory diagram illustrating an example of a call function screen displayed on the display 103. In FIG. 7, an area A21 is an area in which user IDs registered in the contact list are displayed as selection items A211. Each of the selection items A211 displays a user ID of a candidate caller and an icon image G11 indicating the presence of the user. Therefore, the user of the digital television receiver 100 can recognize the state of each user.

The presence of each user changes with time and the presence is updated every time the presence changes. Therefore, for example, if the user specific data 162 stored in the memory 156 is directly operated, the number of times of rewrite may be inappropriately increased because rewrite is performed every time the presence changes. However, the digital television receiver 100 of the first embodiment operates the user specific data 162 stored in the RAM 153 but does not operate the user specific data 162 in the memory 156. In this way, because the data that is frequently updated is stored in the RAM 153, the number of times of rewrite to the memory 156 can efficiently be suppressed.

An area A22 is a display area for displaying video data. In an area A221, video data of a transmitter side, i.e., the destination of a call, is displayed. In an area A222 that is superimposed on the area A221, video data of the source of a call, i.e., video data captured by the camera 143, is displayed. In the area A221, the position where the area A222 is displayed is not limited to the example illustrated in FIG. 7, but the area A222 can be arranged at an arbitrary position.

A button B21 is a button for giving an instruction to start a call. A button B22 is a button for giving an instruction to terminate a call. A button B23 is a button for giving an instruction on logoff. When a user who uses the IP phone selects the selection item A211 of a specific user from the contact list in the area A21 and then selects the button B21, the call function controller 1829 implements a call from the user to the user ID and the video data of the destination of the call and the video data of the source of the call are displayed on the areas A221 and A222, respectively. When the button B22 is selected during the call, the call function controller 1829 disconnects the call. When the button B23 is selected, logoff is performed by the call function controller 1829 and the screen is switched to the display screen of the program contents or the like.

When a broadcast operated by the digital television receiver 100 is being received and displayed or when the other application is being displayed, a call function screen of the IP phone, such as Skype, is not displayed, but the screen can be switched to a display screen of the other application while the user's logon is maintained. When a call is received while the other application is being executed, information indicating the reception of the call is displayed on the display 103 to urge the user to switch the screen to the call function screen.

The operation of the digital television receiver 100 will be explained below with reference to FIGS. 8 to 10.

FIG. 8 is a flowchart of a procedure of a data management process executed at the time of activation of the IP phone program. When the digital television receiver 100 is turned on by the operation of the remote controller 170 or the like, and the modules of the digital television receiver 100 enter the operating states, the CPU 151 activates the IP phone program stored in the ROM 152 to implement the data manager 181 and the IP phone module 182 (Step S11).

The data manager 181 reads the user common data 161 stored in the memory 156 and copies the user common data 161 to the RAM 153 (Step S12).

The IP phone module 182 makes a network setting or a volume setting on the basis of the user common data 161 stored in the RAM 153, so that the IP phone functions is implemented (Step S13). Then, the process is terminated.

As described above, the data manager 181 copies the user common data 161 stored in the memory 156 to the RAM 153 at the time of the activation of the IP phone program, so that the user common data 161 is used for the execution of the IP phone program.

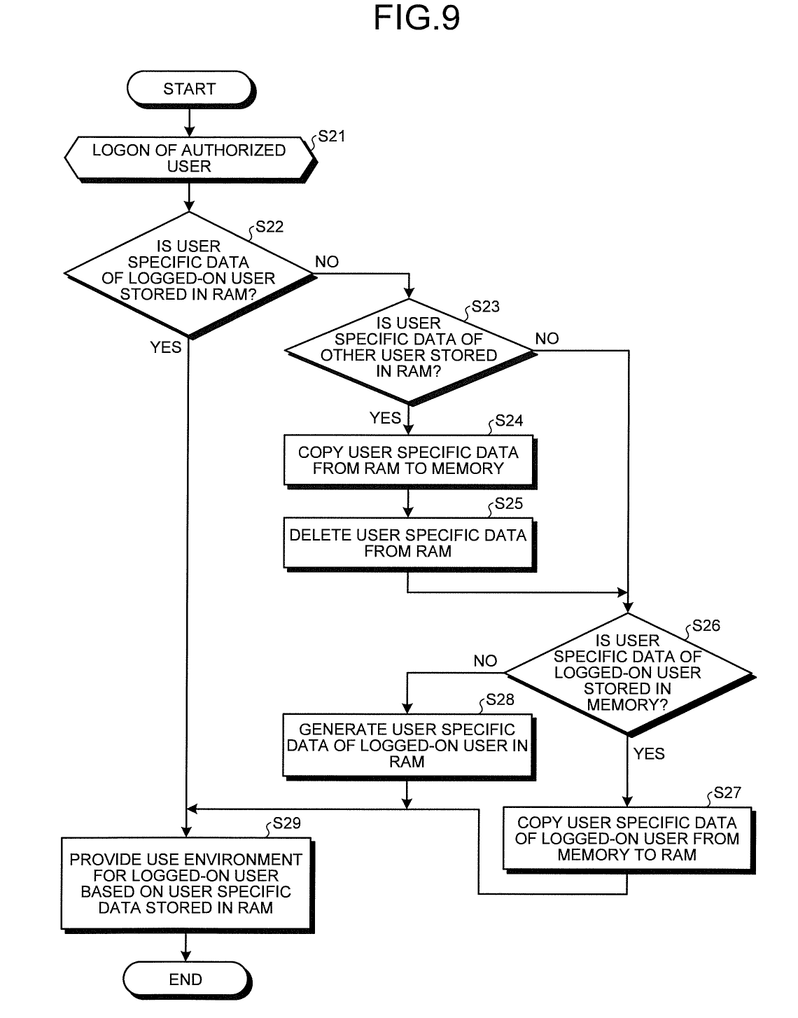

FIG. 9 is a flowchart of a procedure of a data management process executed after logon. When receiving a determination indicating that the user who has input the combination of the user ID and the password to the logon screen (see FIG. 6) is authorized from the IP phone server 300 (Step S21), the data manager 181 determines whether the user specific data 162 corresponding to the user ID of the logged-on user is stored in the RAM 153 (Step S22). When it is determined that the user specific data is stored in the RAM 153 (YES at Step S22), the process directly proceeds to Step S29.

At Step S22, when determining that the user specific data is not stored in the RAM 153 (NO at Step S22), the data manager 181 determines whether the user specific data 162 corresponding to a user ID other than the user ID of the logged-on user is stored in the RAM 153 (Step S23).

At Step S23, when determining that the user specific data 162 of the other user ID is stored in the RAM 153 (YES at Step S23), the data manager 181 deletes the user specific data 162 of the other user ID from the memory 156 and copies the user specific data 162 of the other user ID stored in the RAM 153 to the memory 156 (Step S24). Then, the data manager 181 deletes the user specific data 162 from the RAM 153 (Step S25), and the process proceeds to Step S26.

At Step S23, when determining that the user specific data 162 of any user ID is not stored in the RAM 153 (NO at Step S23), the data manager 181 determines whether the user specific data 162 corresponding to the user ID of the logged-on user is stored in the memory 156 (Step S26). When determining that the user specific data is stored in the memory 156 (YES at Step S26), the data manager 181 reads the user specific data 162 corresponding to the user ID of the logged-on user from the memory 156 and copies it to the RAM 153 (Step S27). Then, the process proceeds to Step S29.

At Step S26, when determining that the user specific data is not stored in the memory 156 (NO at Step S26), the data manager 181 generates the user specific data 162 corresponding to the user ID of the logged-on user in the RAM 153 (Step S28), and the process proceeds to Step S29. When the contact lists or the like of the user IDs are managed by the IP phone server 300, it is possible to acquire a contact list or the like of the input user ID from the IP phone server 300 and store (generate) the contact list as the user specific data 162 in the RAM 153.

Subsequently, the IP phone module 182 displays the call function screen (see FIG. 7) on the display 103 on the basis of the user specific data 162 stored in the RAM 153, so that the usage environment corresponding to the logged-on user is provided (Step S29). Then, the process is terminated.

As described above, in the data management process executed after logon, it is determined whether the user specific data 162 corresponding to the user ID of the logged-on user is stored in the RAM 153 after the user has logged on, and, when the user specific data is stored, the user specific data 162 stored in the RAM 153 is used as it is without copying the user specific data from the memory 156. Therefore, when the same user sequentially performs logon, the user specific data 162 of the user stored in the RAM 153 can be continuously used, so that the number of times of data copying from the memory 156 to the RAM 153 can be suppressed. Furthermore, with the above configuration, it becomes possible to suppress the number of rewrite of the user specific data 162 from the RAM 153 to the memory 156 to a range from the unique number of the logged-on users (the number of unique users) to the number of logons.

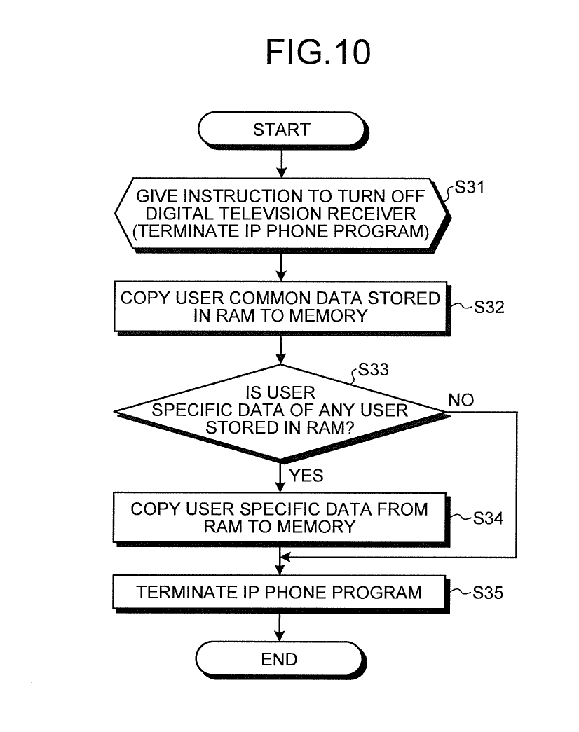

FIG. 10 is a flowchart of a procedure of a data management process executed at the time of termination of the IP phone program. When an instruction to turn off the digital television receiver 100 is given through the operation of the remote controller 170 or the like (Step S31), the data manager 181 deletes the user common data 161 stored in the memory 156 and copies the user common data 161 stored in the RAM 153 to the memory 156 (Step S32).

Subsequently, the data manager 181 determines whether the user specific data 162 of any user ID is stored in the RAM 153 (Step S33). When it is determined that the user specific data 162 of any user ID is not stored in the RAM 153 (NO at Step S33), the process proceeds to Step S35.

On the other hand, at Step S33, when it is determined that the user specific data 162 of any user ID is stored in the RAM 153 (YES at Step S33), the data manager 181 deletes the user specific data 162 of the user ID from the memory 156 and copies the user specific data 162 stored in the RAM 153 to the memory 156 (Step S34). Then, the CPU 151 terminates the IP phone program (Step S35), and the process ends.

As described above, in the data management process executed at the time of the termination, the user common data 161 in the RAM 153 is written back to the memory 156, and, when the user specific data 162 is stored in the RAM 153, the user specific data 162 is written back to the memory 156, at the end of the IP phone program.

As described above, the digital television receiver 100 controls data transfer between the memory 156 and the RAM 153 depending on whether the user specific data 162 of the logged-on user is stored in the RAM 153. Therefore, it is possible to prevent inappropriate access (read/write) to the memory 156, enabling to efficiently manage the user specific data 162 of each user in the memory 156.

### Second Embodiment

A second embodiment will be explained below. In the first embodiment described above, the user specific data 162 of one user is stored in the RAM 153. In the second embodiment, a configuration will be explained in which pieces of the user specific data 162 of a plurality of users are stored in the RAM 153. The same components as those of the first embodiment described above are denoted by the same reference numerals and the same explanation will not be repeated.

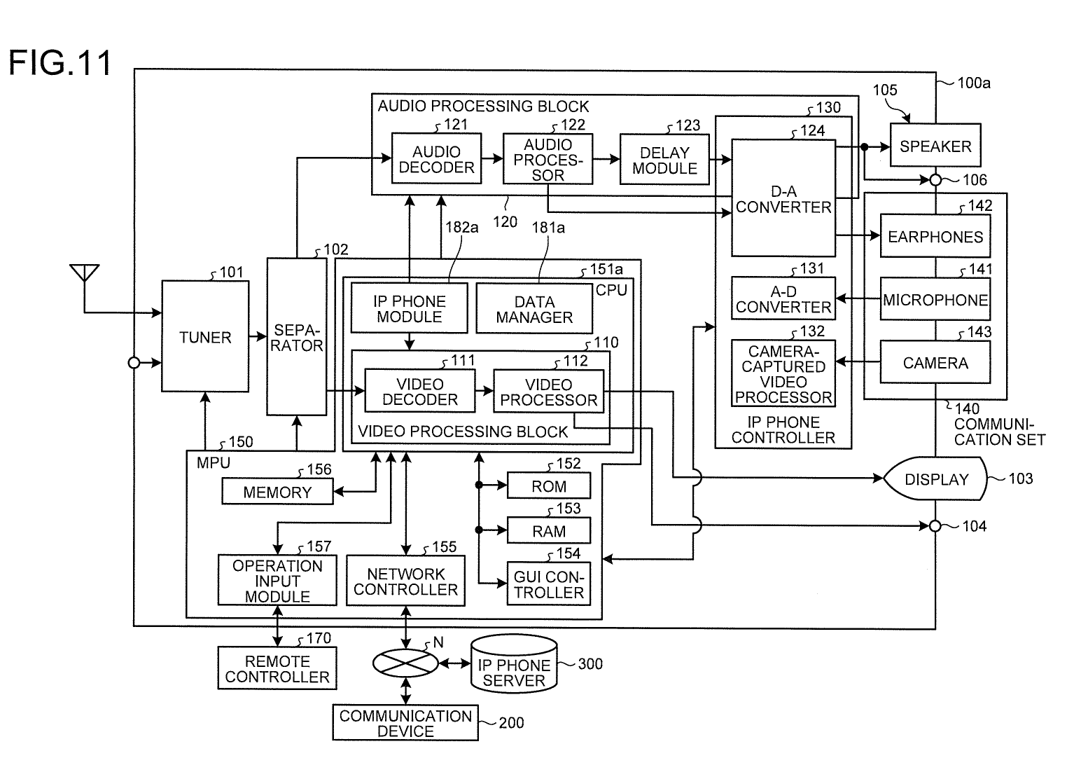

FIG. 11 is a diagram illustrating an example of a configuration of a digital television receiver 100a according to the second embodiment. As illustrated in FIG. 11, the digital television receiver 100a has a different configuration from that of the digital television receiver 100 of the first embodiment described above in that it comprises a data manager 181a and an IP phone module 182a that are implemented through cooperation between a CPU 151a and the IP phone program.

The data manager 181a is a functional module that manages various types of data related to implementation of an IP phone, similarly to the data manager 181 described above. Specifically, the data manager 181a copies the user common data 161 stored in the memory 156 to the RAM 153 when the IP phone program is activated, so that the user common data 161 is used for the execution of the IP phone program.

The data manager 181a also copies all pieces of the user specific data 162 stored in the memory 156 to the RAM 153 when the IP phone program is activated. In the second embodiment, the upper limit (e.g., five users), to which pieces of the user specific data 162 of users can be stored in the RAM 153, is determined in advance. It is also assumed that the pieces of the user specific data 162 of the same number of users as the upper limit can be stored in the memory 156.

When a user ID is input to the logon screen (see FIG. 6) described above at the time of logon of the user, the data manager 181a determines whether the user specific data 162 corresponding to the user ID is stored in the RAM 153. When determining that the user specific data is not stored, the data manager 181a determines whether the number of pieces of the user specific data 162 stored in the RAM 153 reaches the upper limit. When determining that the number of pieces of the user specific data 162 stored in the RAM 153 reaches the upper limit, the data manager 181a compares each piece of the user specific data 162 stored in the RAM 153 with the corresponding user specific data 162 stored in the memory 156 to thereby check whether each piece of the user specific data 162 is updated. When all pieces of the user specific data 162 stored in the RAM 153 are updated, the data manager 181a updates the corresponding user specific data 162 stored in the memory 156 with the updated user specific data 162.

The data manager 181a also determines whether the user specific data 162 corresponding to the user ID of the logged-on user is stored in the RAM 153. When determining that the user specific data is present, the data manager 181a sets the user specific data 162 of the user ID as an object to be used.

When determining that the user specific data 162 corresponding to the user ID of the logged-on user is not stored in the RAM 153 and the number of pieces of the user specific data 162 stored in the RAM 153 is smaller than the upper limit, the data manager 181a generates the user specific data 162 corresponding to the user ID of the logged-on user in the RAM 153 and sets the generated user specific data 162 as an object to be used.

When determining that the user specific data 162 corresponding to the user ID of the logged-on user is not stored in the RAM 153 and the number of pieces of the user specific data 162 reaches the upper limit, the data manager 181a deletes the user specific data 162 whose logon date and time is the oldest of pieces of the non-updated user specific data 162 stored in the RAM 153. Then, the data manager 181a generates the user specific data 162 corresponding to the user ID of the logged-on user in the RAM 153 and sets the generated user specific data 162 as an object to be used. In the second embodiment, the condition for deleting the user specific data 162 is set such that the user specific data 162 that is not updated and that has the oldest logon date and time is to be deleted; however, the condition is not limited to this.

The IP phone module 182a is equipped with the same function as that of the IP phone module 182 described above. The IP phone module 182a displays the call function screen (see FIG. 7) on the display 103 on the basis of the user specific data 162 that is stored in the RAM 153 and that is set as the object to be used by the data manager 181a, thereby providing usage environment corresponding to the logged-on user.

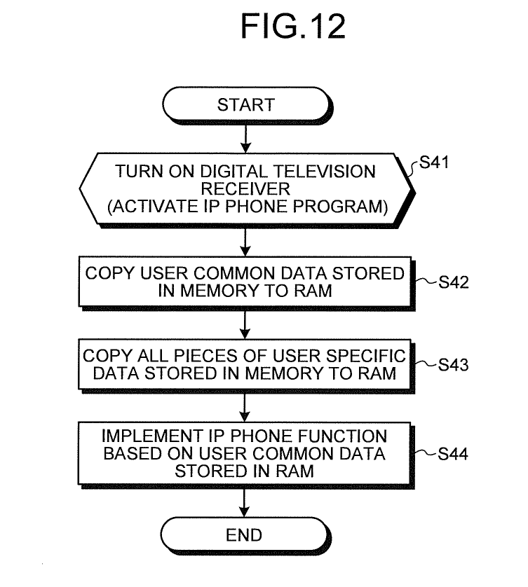

The operation of the digital television receiver 100a will be explained below with reference to FIGS. 12 to 15.

FIG. 12 is a flowchart of a procedure of a data management process executed at the time of activation of the IP phone program. When the digital television receiver 100a is turned on by the operation of the remote controller 170 or the like, and the modules of the digital television receiver 100a enter the operating states, the CPU 151a activates the IP phone program stored in the ROM 152 to implement the data manager 181a and the IP phone module 182a (Step S41).

The data manager 181a reads the user common data 161 stored in the memory 156 and copies the user common data 161 to the RAM 153 (Step S42). Subsequently, the data manager 181a reads all pieces of the user specific data 162 stored in the memory 156 and copies the all pieces of the user specific data 162 to the RAM 153 (Step S43).

Subsequently, the IP phone module 182a makes a network setting or a volume setting on the basis of the user common data 161 stored in the RAM 153, so that the IP phone function is implemented (Step S44). Then, the process ends.

As described above, the data manager 181a copies the user common data 161 stored in the memory 156 to the RAM 153 at the time of the activation of the IP phone program, so that the user common data 161 is used for the execution of the IP phone program. Furthermore, all pieces of the user specific data 162 stored in the memory 156 are copied to the RAM 153 as preparation for logon of a user.

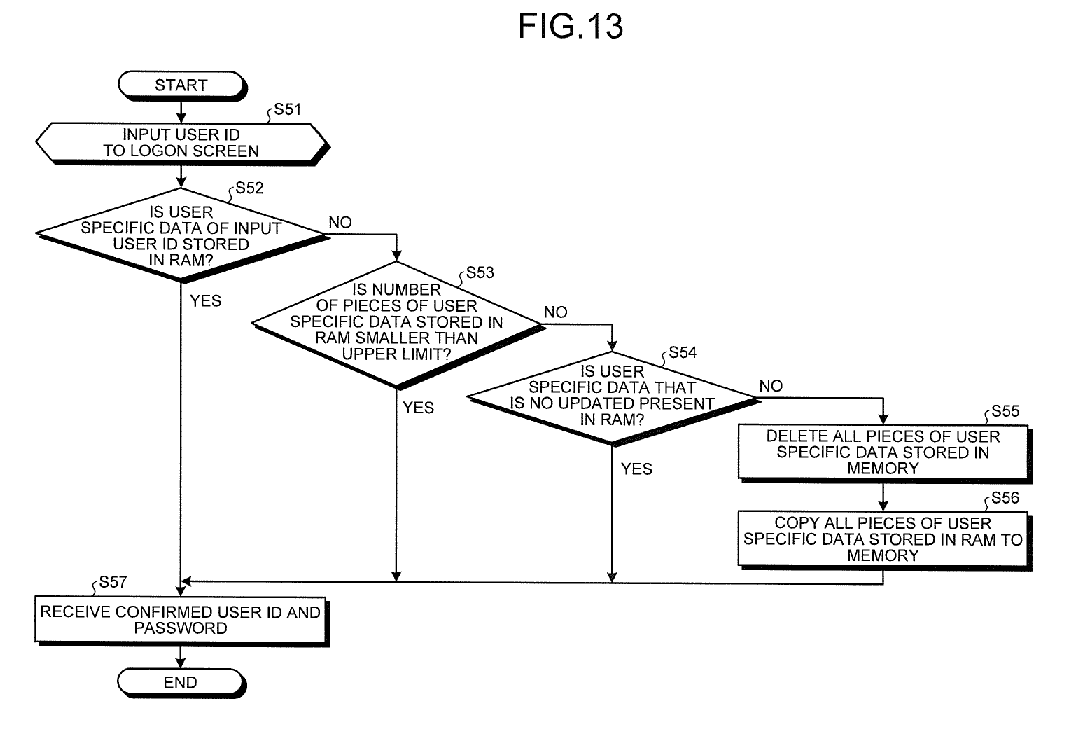

FIG. 13 is a flowchart of a procedure of a data management process executed at the time of logon, which is executed when a user ID is input to the logon screen. In the process, “the time when a user ID is input” means the time when a cursor is moved to the area A12 after a user ID is input to the area All in the logon screen illustrated in FIG. 6. However, this is not limited thereto, and the time may be the time at which input of the password to the area A12 is started.

When receiving input of a user ID to the logon screen (see FIG. 6) (Step S51), the data manager 181a determines whether the user specific data 162 corresponding to the user ID is stored in the RAM 153 (Step S52). When determining that the user specific data 162 is stored in the RAM 153 (YES at Step S52), the process proceeds to Step S57. In the background of the process, a password is input or the button B11 is pressed.

At Step S52, when it is determined that the user specific data 162 is not stored in the RAM 153 (NO at Step S52), the data manager 181a determines whether the number of pieces of the user specific data stored in the RAM 153 is smaller than the upper limit (Step S53). When it is determined that the number of pieces of the user specific data is smaller than the upper limit (YES at Step S53), the process proceeds to Step S57.

At Step S53, when determining that the number of pieces of the user specific data stored in the RAM 153 reaches the upper limit (NO at Step S53), the data manager 181a compares each piece of the user specific data 162 stored in the RAM 153 with the corresponding user specific data 162 stored in the memory 156 to check the update state of the user specific data 162, and determines whether there is the user specific data 162 that is not updated is present (Step S54). When it is determined that the user specific data 162 that is not updated is present (YES at Step S54), the process proceeds to Step S57.

At Step S54, when the all pieces of the user specific data 162 are updated (NO at Step S54), the data manager 181a deletes the all pieces of the user specific data 162 stored in the memory 156 (Step S55) and copies all pieces of the user specific data 162 stored in the RAM 153 to the memory 156 (Step S56), and the process proceeds to Step S57. In the process, rewrite to the memory 156 is performed under the condition in which the all pieces of the user specific data 162 are updated; however, this is not limited thereto. It is possible to rewrite the all pieces of the user specific data 162 from the RAM 153 to the memory 156 regardless of whether the all pieces of the data are updated or not.

At subsequent step S57, when receiving the confirmation of the combination of the user ID and the password input to the logon screen, the IP phone module 182a transmits the combination to the IP phone server 300 (Step S57), and the process is terminated. When a reply indicating that the user is authorized is received from the IP phone server 300, the IP phone module 182a accepts the logon.

As described above, the data manager 181a executes the above data management process at the logon by using the input of the user ID to the logon screen as a trigger, so that the user specific data 162 in the RAM 153 is written back to the memory 156 before the user completes the logon. Therefore, it becomes possible to update the user specific data 162 stored in the memory 156 in parallel to the logon operation performed by the user. As a result, it is possible to prevent occurrence of the wait state for the update after the user has logged on.

When the all pieces of the user specific data 162 in the RAM 153 are already updated, the pieces of the user specific data are written back from the RAM 153 to the memory 156. Therefore, compared with the first embodiment described above, it becomes possible to further reduce the number of times of rewrite of the user specific data 162 from the RAM 153 to the memory 156. In the data management process executed after logon, which will be described below, if the user specific data 162 of a new user is generated in the RAM 153, the generated user specific data 162 is stored (registered) in the memory 156 at the timing of Step S56.

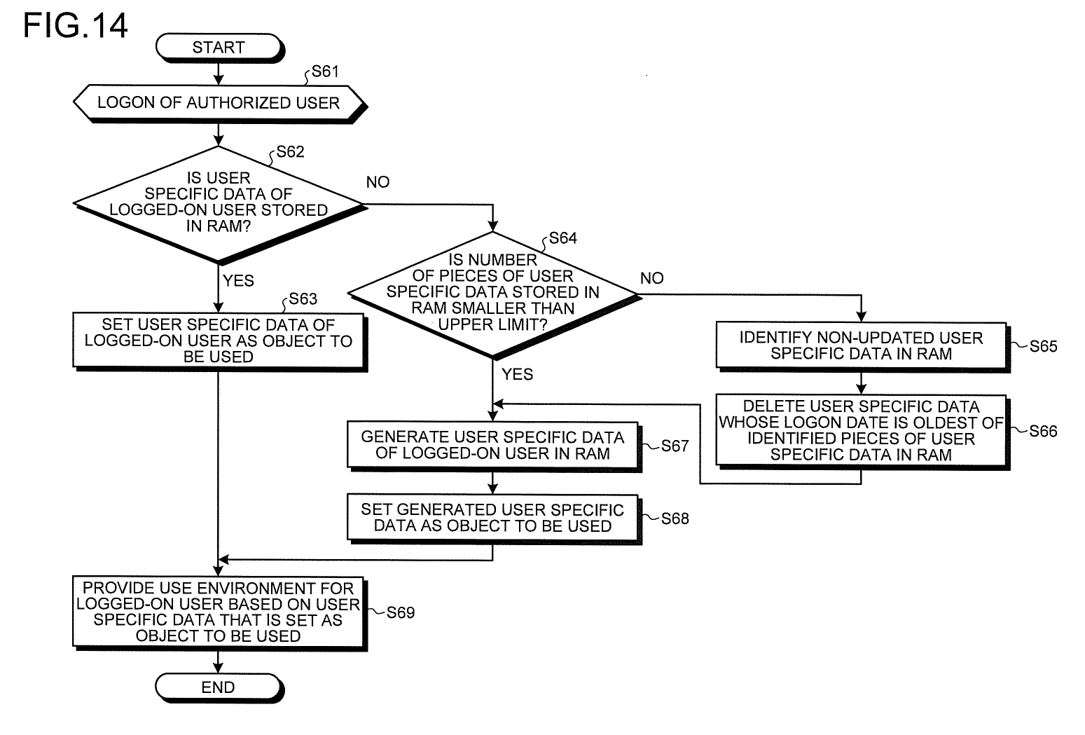

FIG. 14 is a flowchart of a procedure of a data management process executed just after logon. When receiving a determination indicating that the user who has input the combination of the user ID and the password the logon screen (see FIG. 6) is authorized from the IP phone server 300 (Step S61), the data manager 181a determines whether the user specific data 162 corresponding to the user ID of the logged-on user is stored in the RAM 153 (Step S62). When determining that the user specific data 162 corresponding to the user ID of the logged-on user is stored in the RAM 153 (YES at Step S62), the data manager 181a sets the user specific data 162 as an object to be used (Step S63), and the process proceeds to the Step S69.

At Step S62, when determining that the data is not stored in the RAM 153 (NO at Step S62), the data manager 181a determines whether the number of pieces of the user specific data 162 stored in the RAM 153 is smaller than the upper limit (Step S64).

When determining that the number of pieces of the user specific data 162 reaches the upper limit (NO at Step S64), the data manager 181a compares each piece of the user specific data 162 stored in the RAM 153 with the corresponding user specific data 162 stored in the memory 156 to check the update state of each piece of the user specific data 162, and identifies the user specific data 162 that is not updated (Step S65). Then, the data manager 181a deletes the user specific data 162 whose logon date and time is the oldest of the pieces of the user specific data 162 identified at Step S67 (Step S66), and the process proceeds to Step S67.

At Step S64, when determining that the number of pieces of the user specific data 162 is smaller than the upper limit (YES at Step S64), the data manager 181a generates the user specific data 162 corresponding to the user ID of the logged-on user in the RAM 153 (Step S67). Then, the data manager 181a sets the user specific data 162 generated at Step S67 as an object to be used (Step S68), and the process proceeds to Step S69.

The IP phone module 182a displays the call function screen (see FIG. 7) on the display 103 on the basis of the user specific data 162 that is stored in the RAM 153 and that is set as the object to be used, so that the usage environment corresponding to the logged-on user is provided (Step S69). Then, the process is terminated.

As described above, in the data management process performed after logon, it is determined whether the user specific data 162 corresponding to the user ID of the logged-on user is stored in the RAM 153, and, when the user specific data is stored, the user specific data 162 stored in the RAM 153 is used as it is without copying the user specific data from the memory 156. With this configuration, when a user who has already been registered in the digital television receiver 100a is logged on, the user specific data 162 of the user stored in the RAM 153 can be continuously used, so that the number of times of data copying from the memory 156 to the RAM 153 can be suppressed.

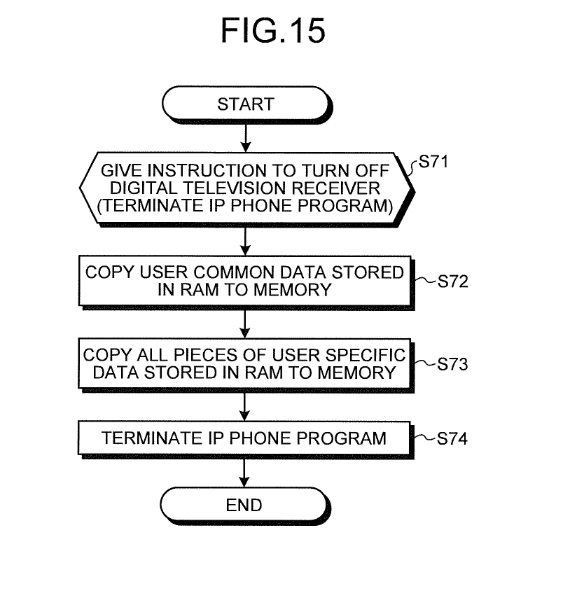

FIG. 15 is a flowchart of a procedure of a data management process executed at the time of termination of the IP phone program. When an instruction to turn off the digital television receiver 100a is given through the operation of the remote controller 170 or the like (Step S71), the data manager 181a deletes the user common data 161 stored in the memory 156 and copies the user common data 161 stored in the RAM 153 to the memory 156 (Step S72).

Subsequently, the data manager 181 deletes all pieces of the user specific data 162 stored in the memory 156 and copies the user specific data 162 stored in the RAM 153 to the memory 156 (Step S73). Then, the CPU 151a terminates the IP phone program (Step S74), and the process ends.

As described above, in the data management process executed at the time of the termination, the user common data 161 and the all pieces of the user specific data 162 in the RAM 153 are written back to the memory 156 at the end of the IP phone program. In the above data management process executed after logon, when the user specific data 162 of a new user is generated in the RAM 153, the generated user specific data 162 is stored (registered) in the memory 156 at Step S73.

As described above, according to the digital television receiver 100a, the pieces of the user specific data 162 of a plurality of users stored in the memory 156 are retained in the RAM 153, and when a user ID is input to the logon screen, data transfer between the memory 156 and the RAM 153 is controlled depending on whether the all pieces of the user specific data 162 are updated or not. Therefore, it is possible to prevent inappropriate access (write/read) to the memory 156, enabling to efficiently manage the user specific data 162 of each user in the memory 156.

The IP phone program executed by the digital television receivers 100 and 100a in the embodiments is provided as being installed in the ROM 152 or the like in advance.

The IP phone program executed by the digital television receivers 100 and 100a in the above embodiments may be provided as being recorded in a computer-readable recording medium, such as a compact disc-read only memory (CD-ROM), a flexible disk (FD), a compact disc recordable (CD-R), or a digital versatile disk (DVD), as a file in an installable or executable format.

The IP phone program executed by the digital television receivers 100 and 100a in the embodiments maybe stored in a computer connected via a network, such as the Internet, so that it can be downloaded therefrom.

The IP phone program executed by the digital television receivers 100 and 100a in the embodiments has a module structure comprising the modules described above (the data managers 181 and 181a and the IP phone modules 182 and 182a). A CPU (processor) as actual hardware reads the IP phone program from the ROM 152 described above and executes the IP phone program, so that the modules described above are loaded on a main storage device and provided on the main storage device.

In the embodiments described above, an example is explained in which the information processor of the embodiment is applied to the digital television receivers 100 and 100a. However, it is possible to apply the information processor to a personal computer (PC), a mobile phone terminal, a recorder and reproducer, a set top box, or a game device.

For example, in the embodiments, the user specific data 162 used in the IP phone program is assumed as an object to be managed; however, this is not limited thereto. The embodiments may be applied to user specific data of other applications that change the usage environment depending on users.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
a first storage comprising a nonvolatile semiconductor memory configured to store therein specific data that is specific to a user in association with identification information for identifying the user;
a second storage configured to be used as a work area;
a data manager configured to copy the specific data stored in the first storage to the second storage at a predetermined timing;
a logon module configured to allow a specific user to logon to the information processor by using the identification information;
a first determination module configured to determine whether the specific data corresponding to identification information of the logged-on user is stored in the second storage; and
a processor configured to perform a predetermined process by using the specific data stored in the second storage when the first determination module determines that the specific data corresponding to the identification information of the logged-on user is stored in the second storage.

2. The information processor of claim 1, wherein when the first determination module determines that the specific data corresponding to the identification information of the logged-on user is not stored in the second storage, the data manager is configured to copy the specific data corresponding to the identification information of the logged-on user from the first storage to the second storage.

3. The information processor of claim 2, wherein when the first determination module determines that specific data corresponding to identification information other than the identification information of the logged-on user is stored in the second storage, the data manager is configured to write back the specific data stored in the second storage to the first storage and thereafter copy the specific data corresponding to the identification information of the logged-on user from the first storage to the second storage.

4. The information processor of claim 2, wherein
when the specific data corresponding to the identification information of the logged-on user is not stored in the first storage, the data manager is configured to generate the specific data corresponding to the identification information of the logged-on user in the second storage, and
the processor is configured to perform a predetermined process by using the specific data generated in the second storage.

5. The information processor of claim 1, wherein the data manager is configured to copy all pieces of specific data stored in the first storage to the second storage before a first logon is performed in the logon module.

6. The information processor of claim 5, further comprising:
a second determination module configured to determine whether number of pieces of specific data stored in the second storage is smaller than a predetermined upper limit when the first determination module determines that the specific data corresponding to the identification information of the logged-on user is not stored in the second storage, wherein
when the second determination module determines that the number of pieces of the specific data is smaller than the upper limit, the data manager is configured to generate the specific data corresponding to the identification information of the logged-on user in the second storage, and
the processor is configured to performs a predetermined process by using the specific data generated in the second storage.

7. The information processor of claim 5, wherein
when the second determination module determines that the number of pieces of the specific data reaches the upper limit, the data manager is configured to delete apiece of specific data that satisfies a predetermined condition from among the pieces of the specific data stored in the second storage, and thereafter generate the specific data corresponding to the identification information of the logged-on user in the second storage, and
the processor is configured to perform a predetermined process by using the specific data generated in the second storage.

8. The information processor of claim 7, wherein the data manager is configured to identify pieces of specific data that are not updated from among the pieces of the specific data stored in the second storage, and delete a piece of specific data whose logon date and time is the oldest of the identified pieces of the specific data.

9. The information processor of claim 5, further comprising:
a third determination module configured to determine whether the specific data corresponding to the identification information of the logged-on user is stored in the second storage at a timing at which the identification information of the user is input when logon of the user is performed by the logon module; and
a fourth determination module configured to determine whether number of pieces of specific data stored in the second storage is smaller than a predetermined upper limit when the third determination module determines that the specific data corresponding to the identification information of the logged-on user is not stored in the second storage, wherein
when the fourth determination module determines that the number of pieces of the specific data reaches the upper limit, the data manager is configured to write back all pieces of the specific data stored in the second storage to the first storage.

10. The information processor of claim 9 wherein when the all pieces of the specific data stored in the second storage are updated, the data manager is configured to write back the all pieces of the specific data stored in the second storage to the first storage.

11. The information processor of claim 1, wherein the processor is configured to provide a use environment for a predetermined application by using the specific data stored in the second storage.

12. The information processor of claim 11, wherein the data manager is configured to write back all pieces of the specific data stored in the second storage to the first storage when the predetermined application is ended.

13. The information processor of claim 11, wherein
the first storage is configured to store therein common data that is common to all users, and
when the predetermined application is started, the data manager is configured to copy the common data stored in the first storage to the second storage to use the common data for the predetermined application.

14. An information processing method implemented in an information processor comprising a first storage that comprises a nonvolatile semiconductor memory configured to store therein specific data that is specific to a user in association with identification information for identifying the user, and comprising a second storage configured to be used as a work area, the information processing method comprising:
copying the specific data stored in the first storage to the second storage at a predetermined timing;
allowing a specific user to logon to the information processor by using the identification information;
determining whether the specific data corresponding to identification information of the logged-on user is stored in the second storage; and
performing a predetermined process by using the specific data stored in the second storage when the specific data is determined to be stored in the second storage.

15. A computer program product applied to an information processor comprising a first storage that comprises a nonvolatile semiconductor memory configured to store therein specific data that is specific to a user in association with identification information for identifying the user, and comprising a second storage configured to be used as a work area,
the computer program product having a non-transitory computer readable medium including programmed instructions, wherein the instructions, when executed by a computer, cause the computer to perform:
copying the specific data stored in the first storage to the second storage at a predetermined timing;
allowing a specific user to logon to the information processor by using the identification information;
determining whether the specific data corresponding to identification information of the logged-on user is stored in the second storage; and
performing a predetermined process by using the specific data stored in the second storage when the specific data is determined to be stored in the second storage.
